(19) United States
(12) Patent Application Publication
(10) Pub. No.: US 2020/0359671 A1
(43) Pub. Date: Nov. 19, 2020

(54) Multiple-Press, Multiple-Expansion Apparatus and Methods for Making Food Products

(71) Applicant: Ideal Snacks Corporation, Liberty, NY (US)

(72) Inventor: Steven Van Poucke, Monroe, NY (US)

(21) Appl. No.: 16/411,769

(22) Filed: May 14, 2019

(51) Int. Cl. A23P 30/36; A23P 30/38

(52) U.S. Cl. CPC A23P 30/36; A23P 30/38

(57) ABSTRACT

Apparatus and methods for making puffed food products are disclosed. Embodiments of the innovative process may include two or more cycles of compression, baking, and expansion to convert raw ingredients into at least one intermediate food product before yielding a final food product. An exemplary apparatus for making such food products may include a control unit coupled to a driving system, a raw material supply system, and at least one heatable mold having at least one movable mold element connected to the driving system. The control unit may electronically control the raw material supply system to input ingredients into the heatable mold and cause the driving system to position the at least one moveable mold element to achieve the multiple cycles of compression, baking, and expansion.

### CROSS-REFERENCE TO RELATED APPLICATIONS

The present application relates to U.S. Utility application Ser. No. 10/504,444 (now U.S. Pat. No. 7,770,513), filed Aug. 12, 2004, which is a national stage application under 35 U.S.C. § 371 from PCT Application No. PCT/EP02/01674, filed Feb. 15, 2002. Each of the above-referenced related applications is incorporated herein by reference in its entirety.

### FIELD

The present innovations generally relate to the manufacture of food products, and more particularly, are directed to multiple-press, multiple-expansion apparatus and methods for making puffed food products from any edible source in the form of crackers, cakes, wafers, or chips of any desired shape, thickness, crispiness and taste.

### BACKGROUND

In the past few decades, a strong trend emerged in the food industry to develop more nutritious and more healthy snacks. Health-conscious consumers increasingly demand food products that include lower fat content, offer more balanced amounts of protein and carbohydrates, or are generally more health-promoting than traditional snacks such as candies, chips, crackers, and the like. As a result, the food industry has attempted to tackle the challenges of making wholesome snack food products out of conventional or alternative ingredients and with less fat or sugar while maintaining or improving the taste and texture of such food products.

In the trend of healthy snacking, puffed snacks have become more and more popular due to their inherent lightness, crispy texture, and ability to accommodate flavoring. As one example, automatic machines for the making of rice crackers and similar puffed or popped granular cakes by pressure-baking and expanding a food-starch containing material in a heated mold are known from the prior art to exist in a number of distinct machine variants.

The present inventor previously disclosed an apparatus and related methods for making puffed food products from starch-containing raw materials. See U.S. Pat. No. 7,770,513.

Referring to FIGS. 1A-1D, a prior-art sequence of mold position steps in the process of producing a puffed cereal wafer or cracker are shown. The mold comprises an upper mold 1 and a lower mold 2, both heatable by means of embedded heating elements (not represented) and movable upwardly and downwardly by being directly driven by hydraulic cylinders as illustrated and explained below. Upper and lower molds generally have punch elements (1′, 2′) which are slidably receivable in a ring mold 3 (preferably fixed but not always required) so as to form therewith a hermetically sealed molding cavity. In FIG. 1A the mold cavity is open, the lower mold 2 has been partially retracted within ring mold 3 while upper mold 1 is lifted, such that a food-starch containing raw material 4 may be dropped into the mold cavity.

FIG. 1B shows pressure-baking of raw material 4. The raw material 4 is crushed, compressed, and heated in a closed cavity by descending the upper mold into the ring mold and then pressurizing either one or both of upper and lower molds. The starch in the raw material is gelatinized, becomes amorphous, and moisture including chemically bound water of the raw material is driven off to build up a high internal vapor pressure.

The built-up vapor pressure is then suddenly released as shown in FIG. 1C by quickly retracting upper and/or lower punches relative to one another within the ring mold. As a result, the compressed raw material explosively expands to form a puffed or popped wafer filling the expansion chamber space defined between the upper mold, the lower mold, and the ring mold.

As shown in FIG. 1D the upper mold is in a lifted position again, whereas the lower punch is moved in the upward direction to raise the cracker to a discharge position flush with the upper surface of the ring mold. A sliding plate of the raw material feed system (not shown) can then push the puffed cracker from the raised lower mold surface into a discharge chute whereafter the baking-puffing cycle can start anew.

In FIGS. 2A-2B, overall side views of a prior-art puffing apparatus are shown comprising a multi-cracker mold, i.e., the upper and lower molds (1, 2) include a plurality of die punches (1′, 2′) which are slidably receivable in a plurality of corresponding die holes (not shown) of a stationary ring mold 3. Lateral to the apparatus there is mounted a raw material supply system 6 comprising a raw material supply line 7 (conduit or hopper) and sliding plates (8, 8′) having suitable perforations and back plates to supply a desired amount of grain or pellet material to each die cavity of the ring mold. Power means (9, 9′, 9″), e.g., air cylinders drive the plates in sliding movements relative to one another and to the ring mold. More in particular, a dosage mechanism (8′) driven by cylinder (9′) brings an exact amount of raw material from supply line (7′) into a transport plate (8). The transport plate (8) is driven by cylinder (9) and positions the raw material precisely over each lower punch element (2′) being then in a cup-forming feed position, i.e., received partly within ring mold openings (3′). Release plate (8″) driven by cylinder (9″) is then actuated to drop or release raw material from transport plate (8) into the ring mold cups or cavities.

On the back side of each movable mold, i.e., on top of upper mold 1 and at the bottom of lower mold 2, there is mounted an upper hydraulic cylinder 10 and a lower drive cylinder 11 respectively, both independently actionable in the respective upward and downward direction to raise or descend the mold elements over a precisely controlled distance and/or to transmit molding pressure to the raw material in the mold cavity according to the desired process stages.

Mounting plates (10′, 11′) attached to apparatus frame (12) form support and fixation members for top and bottom hydraulic cylinders (10, 11) and also bear and guide the connection thereof with the movable mold elements (1, 2). The hydraulic cylinders are powered by a hydraulic oil circuit.

The prior-art process for making puffed food products is illustrated in the flow chart in FIG. 3 with the following steps: (S1) Cup Time: bottom cylinder retracts (goes down), and retracted punches of lower mold form feeding cups within ring mold dies to allow raw material to be dropped into the mold; (S2) Start Time: top cylinder extends (goes down), and upper mold punch goes down inside ring mold die; (S3) Press Time: bottom cylinder extends, and lower mold punch is displaced upwardly, compressing the raw material between the two punches; (S4) Bake Time: all valves remain closed, while both cylinders and punches are kept stationary; (S5) Top Expansion: top cylinder retracts; (S6) Bottom Expansion: bottom cylinder retracts (mostly) simultaneously with top cylinder; (S7) Expansion Delay: delay time of expanded/puffed product inside the retracted punches or expansion-opened molds to allow shape control of finished product; (Optional) Thickness Control: bottom cylinder extends and recompresses already expanded product to a given extent, thereby controlling shape, thickness and surface flatness; (S8) Out Time: top cylinder retracts upper mold above ring mold, and bottom cylinder extends, so that lower mold punch pushes finished product out of ring mold. Thereafter, the cycle starts anew with Step S1 including the supply of starch-containing raw material into the mold cavities.

While the above-described prior-art technique has seen some commercial success in producing puffed food products, various new improvements on the method and/or apparatus are desirable in order to make the production more efficient, to ensure consistent and uniform quality, and to accommodate unique characteristics of a wide variety of ingredients or raw materials, for example.

### SUMMARY OF THE INVENTION

Embodiments of the present invention make significant improvements upon prior-art techniques for making puffed food products. In one implementation, an innovative process may include two or more cycles of compression, baking, and expansion to convert raw ingredients into at least one intermediate food product before yielding a final food product.

According to one particular embodiment of the present invention, a system for making a food product may comprise one or more pressure-molding apparatuses, wherein each of the pressure-molding apparatuses includes a driving system; at least one heatable mold which defines a mold cavity and has at least one movable mold element connected to the driving system that moves the at least one mold element into and out of the mold cavity; a raw material supply system that transports raw material into the mold cavity in the mold; and a control unit coupled to at least said driving system, said at least one heatable mold, and said raw material supply system. The control unit may be configured to (a) cause said raw material supply system to deposit a raw material into said mold cavity, (b) actuate said driving system to position said at least one movable mold element with respect to said mold cavity to compress said raw material, (c) heat at least a portion of said at least one heatable mold to bake said compressed raw material at a first temperature, (d) actuate said driving system to at least partially retract said at least one movable mold element to allow said baked, compressed raw material to expand and take shape into a first intermediate food product, (e) actuate said driving system to re-position said at least one movable mold element with respect to said mold cavity to compress said first intermediate food product, (f) heat at least a portion of said at least one heatable mold to bake said first intermediate food product at a second temperature, and (g) actuate said driving system to at least partially retract said at least one movable mold element to allow said baked, compressed first intermediate food product to expand and take shape into a second intermediate food product. Furthermore, said control unit may dynamically and automatically adjust a heating temperature of said at least one heatable mold, based on a feedback mechanism, to meet at least one of said first temperature and said second temperature.

According to a particular implementation, the driving system may comprise: a fluid reservoir; a pump; a feed line connected to the pump and the fluid reservoir; a return line connected to the fluid reservoir; at least one hydraulic cylinder connected to the feed line and to the return line, the hydraulic cylinder being connected to and moving said at least one movable mold element into and out of the mold cavity; a plurality of valves including at least one feed valve connected in the feed line and at least one return valve connected in the return line; and a unit that controls the operation of the feed and return valves to control the flow of fluid to the hydraulic cylinder and back to the reservoir.

According to another particular embodiment of the present invention, a method for making a food product may comprise the steps of: (a) depositing a raw material into a mold cavity in at least one heatable mold, said mold comprising at least one movable mold element; (b) positioning said at least one movable mold element with respect to said mold cavity to compress said raw material; (c) baking said compressed raw material in said mold at a first temperature; (d) at least partially retracting said at least one movable mold element to allow said baked, compressed raw material to expand and take shape into a first intermediate food product; (e) re-positioning said at least one movable mold element with respect to said mold cavity to compress said first intermediate food product; (f) baking said first intermediate food product in said mold at a second temperature; and (g) at least partially retracting said at least one movable mold element to allow said baked, compressed first intermediate food product to expand and take shape into a second intermediate food product. Furthermore, a heating temperature of said at least one heatable mold may be dynamically and automatically adjusted, based on a feedback mechanism, to meet at least one of said first temperature and said second temperature.

According to a particular implementation, the method may also comprise a step of: (h) re-positioning said at least one movable mold element with respect to said mold cavity to compress said second intermediate food product.

According to another particular implementation, the method may further comprise the steps of: (i) heating at least a portion of said at least one heatable mold to bake said second intermediate food product at a third temperature; and (j) at least partially retracting said at least one movable mold element to allow said baked, compressed second intermediate food product to expand and take shape into a final food product.

One technical effect of the present invention is to introduce substantially more freedom and flexibilities in the configuration of the apparatus and methods for making food items. For example, by splitting the stages during which raw ingredients and/or intermediate food product(s) may be heated or baked, the temperature in each heating/baking stage may be varied in a broader range than if the cooking must occur in a single stage.

Another technical effect of the present invention is the improved and/or variable textures and moist levels of the final food products made from the multiple-press (and/or multiple-expansion) process described herein.

Other benefits, advantages, or technical effects may be appreciated by those of ordinary skill in the art reading the disclosure herein and/or by practicing one or more embodiments of the present invention.

### BRIEF DESCRIPTION OF THE DRAWINGS

The accompanying appendices, drawings, figures, images, etc. illustrate various exemplary, non-limiting, inventive aspects, embodiments, and features (“e.g.,” or “example(s)”) in accordance with the present disclosure:

FIGS. 1A-1D are schematic illustrations of the main steps occurring in a prior-art process of making a puffed cracker using a stationary ring mold and respective upper and lower movable mold elements or punches;

FIGS. 2A-B give side views of a puffing machine arrangement for carrying out the prior-art process steps according to FIGS. 1A-1D;

FIG. 3 shows a flow chart illustrating a prior-art process for making puffed products; and

FIGS. 4A-4B show a flow chart illustrating an exemplary method for making puffed products and corresponding diagrams illustrating core components for implementing the method according to embodiments of the present invention.

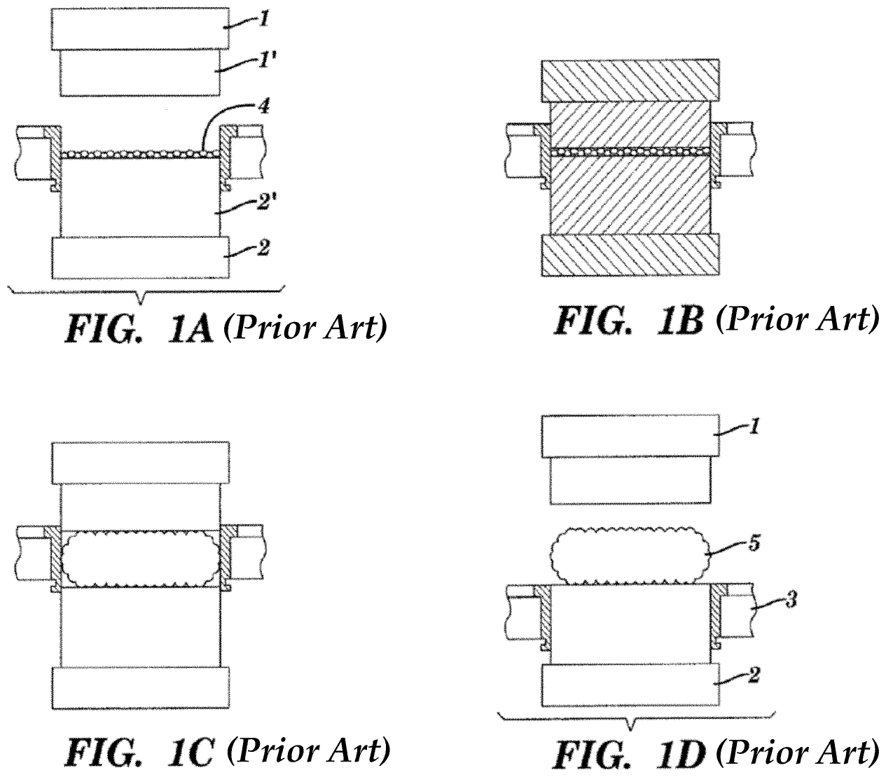

### DETAILED DESCRIPTION OF THE INVENTION

Embodiments of the present invention aim to build upon, and make significant improvements over, the above-described prior-art techniques for making puffed food products. In particular, while the inventor previously suggested an optional “Thickness Control” step of compressing the food item after an initial expansion, embodiments of the present invention teach a second press or compression coupled with a second heating/baking and expansion to more optimally configure the shape, moisture content, and texture of the final food product. The second cycle of compression, baking, and expansion may be controlled based on precisely measured and adjusted baking temperatures and/or compression pressures. According to further embodiments, a third cycle (or more) of compression, baking, and expansion may be added.

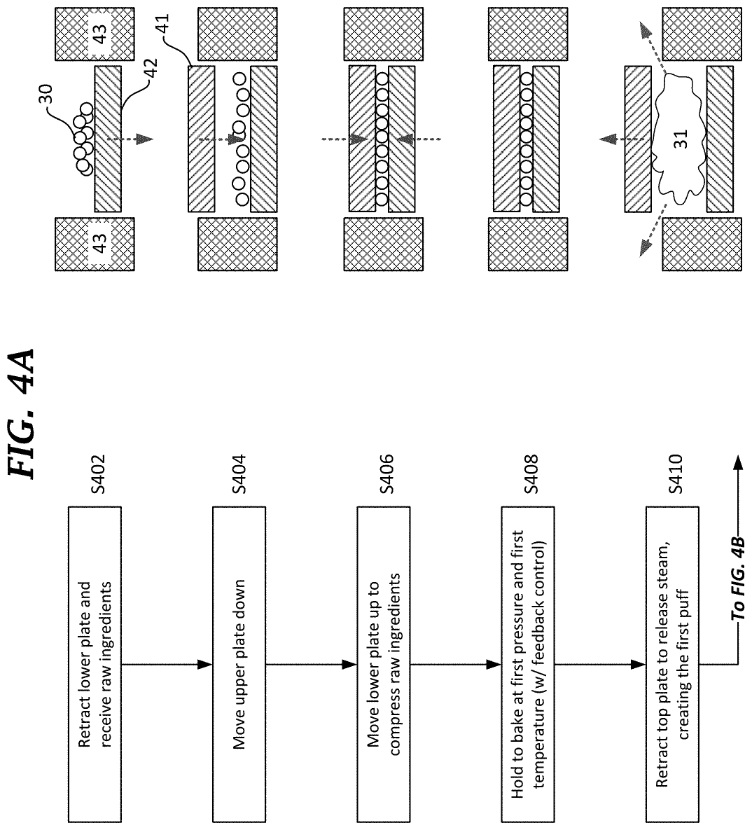

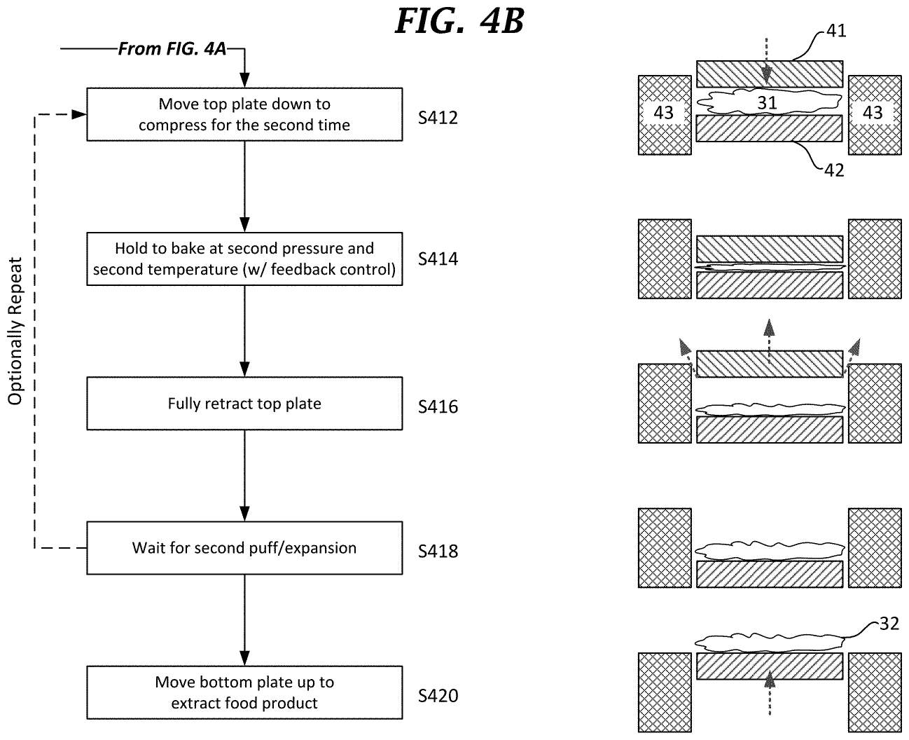

Referring to FIGS. 4A-4B, there are shown both a flow chart illustrating an exemplary method for making puffed food products and corresponding diagrams illustrating core components for implementing the method according to embodiments of the present invention.

In the illustrative diagrams, the cross-sectional view of a ring mold element 43 is shown along with an upper mold plate 41 and a lower mold plate 42 in respective positions depending on the corresponding steps or stages of the manufacturing process. It should be noted that these simplified illustrations of mold elements are intended to assist in the explanation of the numbered steps or stages of the exemplary food-making process; the present invention is not limited to the use of such mold elements or their exemplary configurations as shown in these drawings.

In Step S402, the lower plate 42 may be retracted in the ring mold element 43 to form a feed cup (or a hermetically sealed molding cavity) such that an appropriate amount of raw ingredients 30 may be deposited.

According to embodiments of the present invention, the raw ingredients may be or include one or more of the following: wheat, rye, maize (corn), rice, sago, sorghum, triticale, millet, beans, potatoes, or starches from these or similar sources. According to other embodiments, the raw ingredients may alternatively or additionally include protein-rich food materials or protein therefrom. Other alternative ingredients may include one or more of the following: whole pieces of beans and peas, such as green and yellow peas, black bean, garbanzo bean, chick peas; whole seeds, such as sesame, quinoa, and chia; extruded pellets, such as soy-based protein pellets, pellets containing dried fruits, and vegetable pellets made from spinach, carrots, or beet etc.

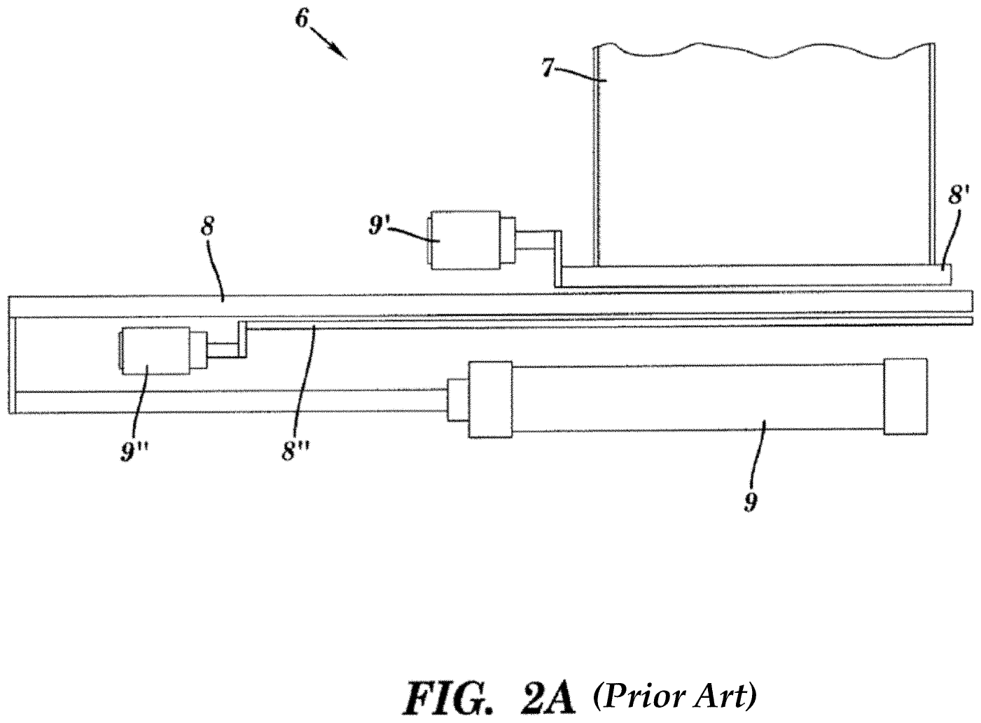

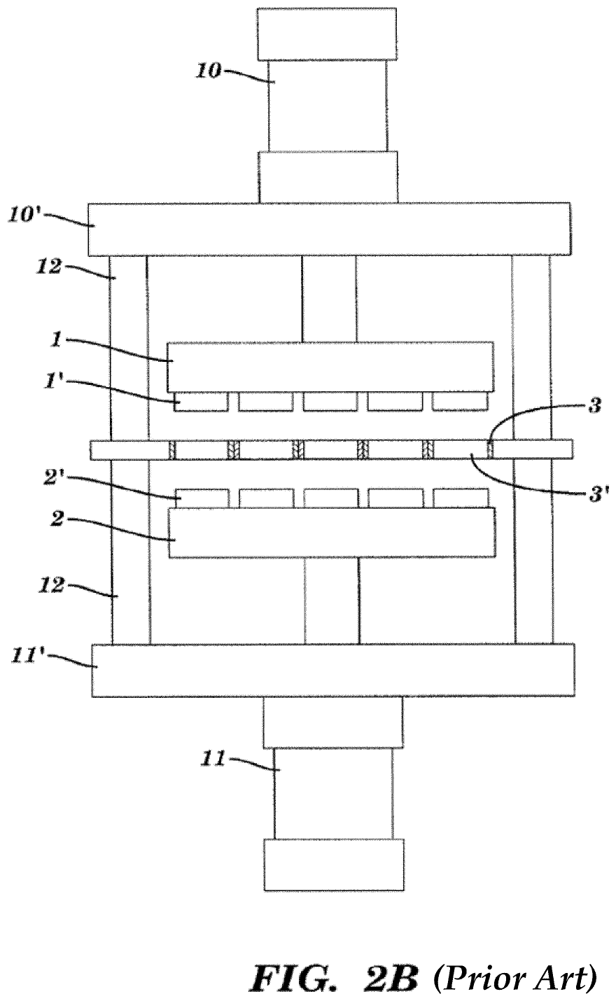

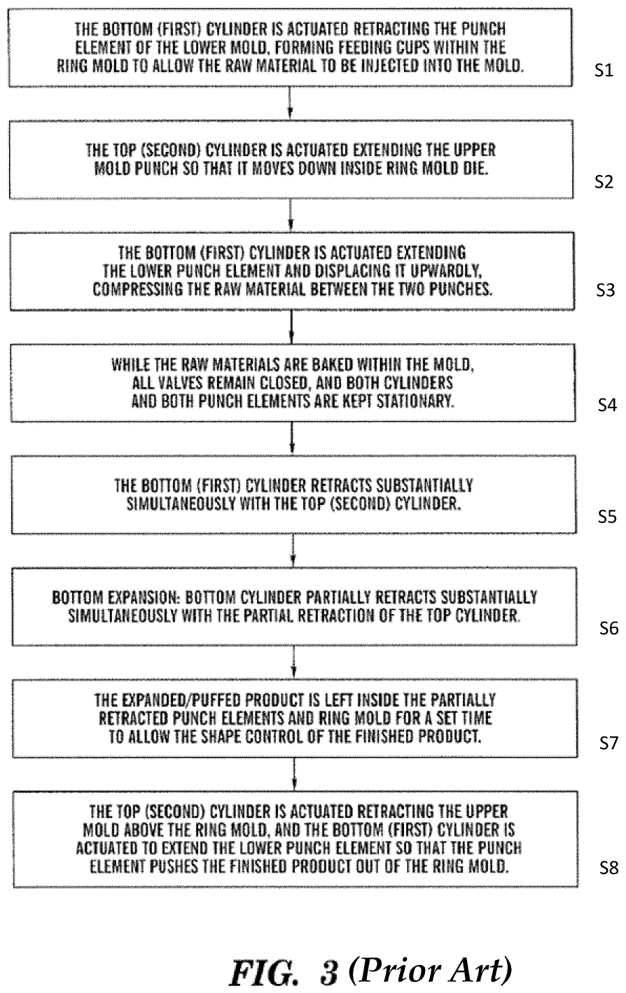

The raw ingredients 30 may be deposited (e.g., injected, dropped, slided) into the temporarily formed feed cup by the raw material supply system 6 shown in FIG. 2A or with a similar mechanism. The raw ingredients may have been pre-processed, such as chopped or ground to powder or granular forms and/or mixed with condiments, before being supplied to the feed cup. According to one embodiment of the present invention, pre-processing or preparation of the raw ingredients may include pre-heating them to a desired temperature, such as a temperature closer to a subsequent baking temperature than to room temperature. Other examples of pre-processing may include steaming of the raw ingredients which may modify the starch content and add moisture thereto. Apart from addition of moisture, the raw ingredients may be pre-processed to remove moisture.

Retraction of the lower plate 42 may be achieved through any of a variety of actuation means. For example, the lower plate 42 may be coupled to, and directly driven by, at least one hydraulic cylinder such as shown in FIG. 2B and in more detail in FIG. 5 described below. The extent of the lower plate 42's retraction may depend on the amount of the raw ingredients 30: if the raw ingredients require more space inside the feed cup, then the lower plate 42 should be lowered further or deeper within the ring mold 43.

In Step S404, the upper plate 41 may be moved down towards the lower plate 42 which has the raw ingredients 30 thereon.

Similar to the movement of the lower plate 42, the upper plate 41 may be moved through any of a variety of actuation means. For example, the upper plate 41 may also be coupled to, and directly driven by, at least one hydraulic cylinder such as shown in FIG. 2B and FIG. 5.

In Step S406, the lower plate may be moved up at substantially the same time as (or before or after) the lowering of the upper plate 41 in Step S404. As a result, the raw ingredients may be spread between and compressed by the upper and lower plates. According to some embodiments of the present invention, the pressure applied by the two mold plates may be controlled by coordinating their respective actuation means such as hydraulic pressures of corresponding driving cylinders.

Then, in Step S408, the mold plates 41 and 42 are held in place and heated in order to bake the raw ingredients 30 at a first pressure and a first temperature.

According to embodiments of the present invention, the mold plates 41 and 42 may be heated to desired temperature(s) based on a number of methods. For example, heating elements may be attached to or embedded within the mold plates 41 and 42 respectively and dynamically controlled based on precise measurements of their surface temperatures. Real-time sensing of the mold plates' surface temperatures may allow continuous, precise adjustments of the heating elements' thermal inputs to the raw ingredients.

The duration of the baking in Step S408 may be a fixed number of seconds, for example, based on empirical data obtained from processing the same raw ingredients. Alternatively, the baking may be ended based on detection of changes in temperature and/or pressure in or near the mold cavity. For example, the detected onset of more rapid increase in temperature and/or the plateauing of pressure increase might provide the cue to end or wind down Step S408.

The baking temperature, duration, and applied pressure may have significant effects on the moisture level and texture of the resulting food product. According to some embodiments of the present invention, temperatures of the mold plates may vary generally between 200 and 320° C., and more preferably between 220 and 260° C.; while the baking duration may vary generally from 0.25 to 10 seconds, and more preferably between 1.0 and 2.5 seconds. The limits to the baking temperature and time are chosen to prevent under-cooking and over-cooking (or burning) of the ingredients; and the multiple-press concept according to embodiments of the present invention widens these limits significantly. For example, while a certain product will burn after being baked at 230° C. for 2 seconds, it may be possible to bake the same product at 230° C. three times for one second each time. The latter (multi-press) process may create an end product with a crispier texture and lower moisture content. Due to the very short baking time, the pressure applied to the mold plates becomes important, including both the amount of pressure, the duration of the pressure, and the speed at which the pressure is applied. Therefore, according to some embodiments, it may be desirable to equip each apparatus or related hydraulic system with a flow control valve (e.g., with a needle-controlled orifice) in order to adjust the application of pressure more precisely.

Next, in Step S410, the top plate 41 may be retracted (i.e., raised) to open up the mold cavity. In the alternative or in addition, the lower plate 42 may be retracted (i.e., lowered) to achieve a same or similar effect. The mold plate movement(s), creating more space in the mold cavity, release the steam or vapor suddenly from the mold cavity, thereby causing the now baked raw ingredients to rapidly expand.

According to some embodiments of the present invention, the retraction of one or both mold plates may be controlled such that the expansion of the baked raw ingredients is essentially unconstrained by the dimensions of the mold cavity. That is, the mold plate(s) may be retracted far enough and fast enough so as to allow the expansion to reach its maximum extent possible. According to other embodiments, the mold plate(s) need not be retracted so far or so fast as to permit the fullest possible expansion. Instead, the mold plate retraction may only permit the expansion to a fraction (e.g., ⅓, ½, or ¾) of its full potential. According to some embodiments, Step S410 may be configured to allow some dwell time in order to allow the desired amount of expansion to be achieved.

At the end of Step S410, the raw ingredients 30 have been converted (through compression, baking, and expansion) into a first intermediate food product 31.

In Step S412, the top plate 41 may again be moved down relative to the lower plate 42 (or vice versa) to compress the first intermediate food product 31. As a result, the puffed shape of the first intermediate food product 31 may be substantially flattened.

In one alternative embodiment of the present invention, additional ingredients, condiments, and/or flavoring may be optionally added to the mold cavity during Step S412. In another alternative embodiment, the upper plate 41 may be replaced by another upper plate of a different shape or surface profile or modified by an attachment to achieve a same or similar effect.

In Step S414, the mold plates 41 and 42 may be held in place and heated in order to bake the now compressed, first intermediate food product 31 at a second pressure and a second temperature.

Similar to Step S408, the mold plates 41 and 42 may be heated to desired temperature(s) based on a number of methods, such as the use of heating elements attached to or embedded within the mold plates 41 and 42 respectively and dynamically controlled based on real-time feedback. The duration of the baking in Step S414 may similarly be either a fixed amount based on empirical data or dynamically determined based on detection of changes in temperature and/or pressure in or near the mold cavity. Typically, the second baking duration and pressure may be different from corresponding parameters for the previous baking step (S408).

In Step S416, the top plate 41 may be fully retracted (i.e., raised) to allow release of additional steam or vapor from the mold cavity, thereby causing the now compressed and baked first intermediate food product 31 to expand.

In Step S418, the process may be paused for a period of time (e.g., a few seconds) to allow the first intermediate food product 31 to fully expand and take a final shape.

At the end of Step S418, the first intermediate food product 31 have been converted (through the second cycle of compression, baking, and expansion) into a final food product 32.

According to alternative embodiments of the present invention, what is produced at the end of Step S418 may be merely a second intermediate food product. Optionally, the process may loop back to Step S412 to repeat at least one more cycle of compression, baking, and expansion to the second intermediate food product before yielding a final food product 32.

As mentioned above, a third cycle or additional cycles may, among other things, extend the limits of temperature, time, and pressure and offer more flexibilities and capabilities for processing a wide variety of raw ingredients and for achieving final food products of desired characteristics. For example, some whole beans and grains cannot be crushed sufficient in a single press, while a multiple-press method may transform those ingredients more fully—which may be especially important for the creation of baby food. With the ability to compress and bake the ingredients multiple times, the final food product may have a crispier texture, adopt a different shape/profile, and contain less harmful microscopic organisms.

Finally, in Step S420, the bottom plate 42 may be moved up for extraction of the final food product 32. For example, the bottom plate 42 may be raised to be flush with (or slightly above) the top surface of the ring mold 43, whereupon the final food product 32 may be pushed or blown off into a discharge chute or another collection receptacle.

At the completion of Step S420, the process may loop back to Step S402 to retract the lower plate 42 and start another round of making puffed food products.

As may be appreciated by those skilled in the art, the steps of the exemplary process may be at least partially automated with electronically controlled components and/or a microprocessor, microcontroller, or microcomputer. For example, an apparatus according to an embodiment of the present invention may include a control unit coupled to a driving system, a raw material supply system, and at least one heatable mold having at least one movable mold element connected to the driving system. The control unit may preferably be programmable to electronically control the raw material supply system to input ingredients into the heatable mold, to cause the driving system to position the at least one moveable mold element, and to bake the ingredients and/or intermediate product(s), all according to the process steps illustrated in FIGS. 4A-4B.

As may be appreciated by those skilled in the art, each diagram of mold elements corresponding to a method step shown in FIGS. 4A-4B represents one production unit of a mold assembly in a larger manufacturing apparatus such as partially shown in FIGS. 2A and 2B.

It should be noted that the mold assemblies shown in the drawings are exemplary only and many of their aspects may be designed or configured differently to accommodate manufacturing needs for different ingredients and final food products. For example, although the upper and lower punch elements or mold plates are shown as having flat food-contacting surfaces in parallel to each other, they can have other surface profiles and/or relative configurations, such as grooves or slots, concave, convex, or wavy contours, or complementary profiles. In addition, the ring dies may have other, non-circular shapes such as triangle, hexagon, octagon, square, or rectangle. Or, the punch elements and ring dies may be easily replaced with components having the alternative designs. Exemplary shapes of the mold plates and ring dies may include but are not limited to: French fries, gold fish, star, tear drop, cloud, heart, oval, and dog bone.

In order to address various issues and advance the art, the entirety of this application (including the Cover Page, Title, Headings, Field, Background, Summary, Brief Description of the Drawings, Detailed Description, Claims, Abstract, Figures, Appendices and/or otherwise) shows, by way of illustration, various exemplary embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. That alternative embodiments may not have been presented for a specific portion of the innovations or that further undescribed alternative embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized, and functional, logical, operational, organizational, structural and/or topological modifications may be made without departing from the scope and/or spirit of the disclosure. Thus, all examples and/or embodiments are deemed to be non-limiting throughout this disclosure. Also, no inference should be drawn regarding those embodiments discussed herein relative to those not discussed herein other than it is as such for purposes of reducing space and repetition. In addition, the disclosure includes other innovations not presently claimed. Applicant reserves all rights in those presently unclaimed innovations, including the right to claim such innovations, file additional applications, continuations, continuations-in-part, divisions, and/or the like thereof.

What is claimed is:

1. A system for making a food product, comprising:
one or more pressure-molding apparatuses, each of the pressure-molding apparatuses including:
a driving system;
at least one heatable mold which defines a mold cavity and has at least one movable mold element connected to the driving system that moves the at least one mold element into and out of the mold cavity;
a raw material supply system that transports raw material into the mold cavity in the mold; and
a control unit coupled to at least said driving system, said at least one heatable mold, and said raw material supply system, said control unit configured to:
(a) cause said raw material supply system to deposit a raw material into said mold cavity,
(b) actuate said driving system to position said at least one movable mold element with respect to said mold cavity to compress said raw material,
(c) heat at least a portion of said at least one heatable mold to bake said compressed raw material at a first temperature,
(d) actuate said driving system to at least partially retract said at least one movable mold element to allow said baked, compressed raw material to expand and take shape into a first intermediate food product,
(e) actuate said driving system to re-position said at least one movable mold element with respect to said mold cavity to compress said first intermediate food product,
(f) heat at least a portion of said at least one heatable mold to bake said first intermediate food product at a second temperature, and
(g) actuate said driving system to at least partially retract said at least one movable mold element to allow said baked, compressed first intermediate food product to expand and take shape into a second intermediate food product;
wherein said control unit dynamically and automatically adjusts a heating temperature of said at least one heatable mold, based on a feedback mechanism, to meet at least one of said first temperature and said second temperature.

2. The system according to claim 1, wherein said at least one heatable mold further comprises a ring mold element, said ring mold element slidably receives said at least one mold element.

3. The system according to claim 2, wherein said ring mold element slidably receives said at least one mold element in a fluid-tight manner.

4. The system according to claim 1, wherein said driving system comprises:
a fluid reservoir;
a pump;
a feed line connected to the pump and the fluid reservoir;
a return line connected to the fluid reservoir;
at least one hydraulic cylinder connected to the feed line and to the return line, the hydraulic cylinder being connected to and moving said at least one movable mold element into and out of the mold cavity;
a plurality of valves including at least one feed valve connected in the feed line and at least one return valve connected in the return line; and
a unit that controls the operation of the feed and return valves to control the flow of fluid to the hydraulic cylinder and back to the reservoir.

5. The system according to claim 1, wherein said first temperature is the same as said second temperature.

6. The system according to claim 1, wherein said second intermediate food product is retracted from said at least one heatable mold as a final food product.

7. The system according to claim 1, wherein said control unit is further configured to:
(h) actuate said driving system to re-position said at least one movable mold element with respect to said mold cavity to compress said second intermediate food product.

8. The system according to claim 7, wherein said control unit is further configured to:
(i) heat at least a portion of said at least one heatable mold to bake said second intermediate food product at a third temperature; and
(j) actuate said driving system to at least partially retract said at least one movable mold element to allow said baked, compressed second intermediate food product to expand and take shape into a final food product.

9. The system according to claim 8, wherein said third temperature is the same as said first temperature or said second temperature.

10. A method for making a food product, comprising:
(a) depositing a raw material into a mold cavity in at least one heatable mold, said mold comprising at least one movable mold element;
(b) positioning said at least one movable mold element with respect to said mold cavity to compress said raw material;
(c) baking said compressed raw material in said mold at a first temperature;
(d) at least partially retracting said at least one movable mold element to allow said baked, compressed raw material to expand and take shape into a first intermediate food product;
(e) re-positioning said at least one movable mold element with respect to said mold cavity to compress said first intermediate food product;
(f) baking said first intermediate food product in said mold at a second temperature; and
(g) at least partially retracting said at least one movable mold element to allow said baked, compressed first intermediate food product to expand and take shape into a second intermediate food product;
wherein a heating temperature of said at least one heatable mold is dynamically and automatically adjusted, based on a feedback mechanism, to meet at least one of said first temperature and said second temperature.

11. The method according to claim 10, wherein said first temperature is the same as said second temperature.

12. The method according to claim 10, wherein said second intermediate food product is retracted from said at least one heatable mold as a final food product.

13. The method according to claim 10, further comprising:
(h) re-positioning said at least one movable mold element with respect to said mold cavity to compress said second intermediate food product.

14. The method according to claim 13, further comprising:
(i) heating at least a portion of said at least one heatable mold to bake said second intermediate food product at a third temperature; and
(j) at least partially retracting said at least one movable mold element to allow said baked, compressed second intermediate food product to expand and take shape into a final food product.

15. A system for making a food product, comprising:
one or more pressure-molding apparatuses, each of the pressure-molding apparatuses including:
a driving system;
at least one heatable mold which defines a mold cavity and has at least one movable mold element connected to the driving system that moves the at least one mold element into and out of the mold cavity;
a raw material supply system that transports raw material into the mold cavity in the mold; and
a control unit coupled to at least said driving system, said at least one heatable mold, and said raw material supply system, said control unit configured to:
(a) cause said raw material supply system to deposit a raw material into said mold cavity,
(b) actuate said driving system to position said at least one movable mold element with respect to said mold cavity to compress said raw material,
(c) heat at least a portion of said at least one heatable mold to bake said compressed raw material at a first temperature,
(d) actuate said driving system to at least partially retract said at least one movable mold element to allow said baked, compressed raw material to expand and take shape into a first intermediate food product,
(e) actuate said driving system to re-position said at least one movable mold element with respect to said mold cavity to compress said first intermediate food product,
(f) heat at least a portion of said at least one heatable mold to bake said first intermediate food product at a second temperature,
(g) actuate said driving system to at least partially retract said at least one movable mold element to allow said baked, compressed first intermediate food product to expand and take shape into a second intermediate food product, and
(h) actuate said driving system to re-position said at least one movable mold element with respect to said mold cavity to compress said second intermediate food product.

16. The system according to claim 15, wherein said first temperature is the same as said second temperature.

17. The system according to claim 15, wherein said control unit is further configured to:
(i) heat at least a portion of said at least one heatable mold to bake said second intermediate food product at a third temperature; and
(j) actuate said driving system to at least partially retract said at least one movable mold element to allow said baked, compressed second intermediate food product to expand and take shape into a final food product.

18. A method for making a food product, comprising:
(a) depositing a raw material into a mold cavity in at least one heatable mold, said mold comprising at least one movable mold element;
(b) positioning said at least one movable mold element with respect to said mold cavity to compress said raw material;
(c) baking said compressed raw material in said mold at a first temperature;
(d) at least partially retracting said at least one movable mold element to allow said baked, compressed raw material to expand and take shape into a first intermediate food product;
(e) re-positioning said at least one movable mold element with respect to said mold cavity to compress said first intermediate food product;
(f) baking said first intermediate food product in said mold at a second temperature;
(g) at least partially retracting said at least one movable mold element to allow said baked, compressed first intermediate food product to expand and take shape into a second intermediate food product; and
(h) re-positioning said at least one movable mold element with respect to said mold cavity to compress said second intermediate food product.

19. The method according to claim 18, wherein said first temperature is the same as said second temperature.

20. The method according to claim 18, further comprising:
(i) baking said second intermediate food product at a third temperature; and
(j) at least partially retracting said at least one movable mold element to allow said baked, compressed second intermediate food product to expand and take shape into a final food product.
